(19) United States
(12) Patent Application Publication
(10) Pub. No.: US 2018/0304681 A1
(43) Pub. Date: Oct. 25, 2018

(54) MECHANICAL GUIDING SYSTEM

(71) Applicants: Thomas Robert Gehring, Keuterville, ID (US); Bruce Afton King, Grangeville, ID (US)

(72) Inventors: Thomas Robert Gehring, Keuterville, ID (US); Bruce Afton King, Grangeville, ID (US)

(21) Appl. No.: 15/956,566

(22) Filed: Apr. 18, 2018

Related U.S. Application Data
(60) Provisional application No. 62/487,314, filed on Apr. 19, 2017.

(51) Int. Cl. B60B 29/00

(52) U.S. Cl. CPC B60B 29/001

(57) ABSTRACT

A system for guiding a part, including a through-hole, toward a desired position. The system includes a connector and a handle member. The connector is configured to be removably attached to the desired position. The connector is also configured to pass through the through-hole. The handle member has a distal portion connected to the connector. The distal portion is configured to pass through the through-hole. The handle member is configured to lift the part while the connector is attached to the desired position and a portion of the handle member is within the through-hole. The handle member is configured to allow the part to slide therealong and into the desired position while the part is lifted by the handle member. The connector is removable from the desired position after the part has been slid into the desired position.

### CROSS REFERENCE TO RELATED APPLICATION(S)

This application claims the benefit of U.S. Provisional Application No. 62/487,314, filed on Apr. 19, 2017, which is incorporated herein by reference in its entirety.

### BACKGROUND OF THE INVENTION

### Field of the Invention

The present invention is directed generally to systems configured to help guide a part into a desired position as the part is being lifted by a user.

### Description of the Related Art

Manually lifting a part and mounting it onto a horizontally oriented mount (e.g., a peg, a bolt, and the like) or inserting the part into an opening can be quite difficult, particularly if the part is heavy. This problem is even more challenging if the user must look through or around the part to see where the mount or opening is located while lifting the part. Therefore, a need exists for systems configured to help guide a part as the part is being lifted. The present application provides this and other advantages as will be apparent from the following detailed description and accompanying figures.

### BRIEF DESCRIPTION OF THE SEVERAL VIEWS OF THE DRAWING(S)

FIG. 1 is an illustration of a user inserting connectors of a first embodiment of a system through a pair of through-holes formed in a wheel.

FIG. 2 is an illustration of the user connecting the connectors to a pair of lugs.

FIG. 3 is an illustration of the user lifting the wheel by lifting upwardly on a handle member of the first embodiment of the system.

FIG. 4 is an illustration of the user sliding the wheel along the handle member and onto the connectors.

FIG. 5 is an illustration of the user installing at least one lug nut on one of the lugs.

FIG. 6 is an illustration of the user removing the connectors from the pair of lugs.

FIG. 7 is a side view of the first embodiment of the system.

FIG. 8 is a longitudinal cross-sectional view of one of lugs received inside one of the connectors while the wheel is supported by the lugs.

FIG. 9A is a perspective view of the first embodiment of the system including a pair of adapters that convert the connectors into male connectors that may be inserted into a pair of holes.

FIG. 9B is a perspective view of the first embodiment of the system including a pair of stud bolts that may be inserted into the pair of holes and received by the connectors.

FIG. 10 is a longitudinal cross-sectional view of a first embodiment of a connector that may be used to implement each of the connectors of the first embodiment of the system.

FIG. 11 is a longitudinal cross-sectional view of a second embodiment of a connector that may be used to implement each of the connectors of the first embodiment of the system.

FIG. 12 is an exploded longitudinal cross-sectional view of a third embodiment of a connector that may be used to implement each of the connectors of the first embodiment of the system.

FIG. 13 is a side view of the third embodiment of the connector.

FIG. 14 is a longitudinal cross-sectional view of the third embodiment of the connector including inside threads.

FIG. 15 is a perspective view of a second embodiment of the system including a first embodiment of a pair of stands.

FIG. 16 is a fragmented side view of the second embodiment of the system omitting the stands.

FIG. 17 is a perspective view of the first embodiment of the stands.

FIG. 18 is a perspective view of the second embodiment of the system including a second embodiment of the pair of stands.

Like reference numerals have been used in the figures to identify like components.

### DETAILED DESCRIPTION OF THE INVENTION

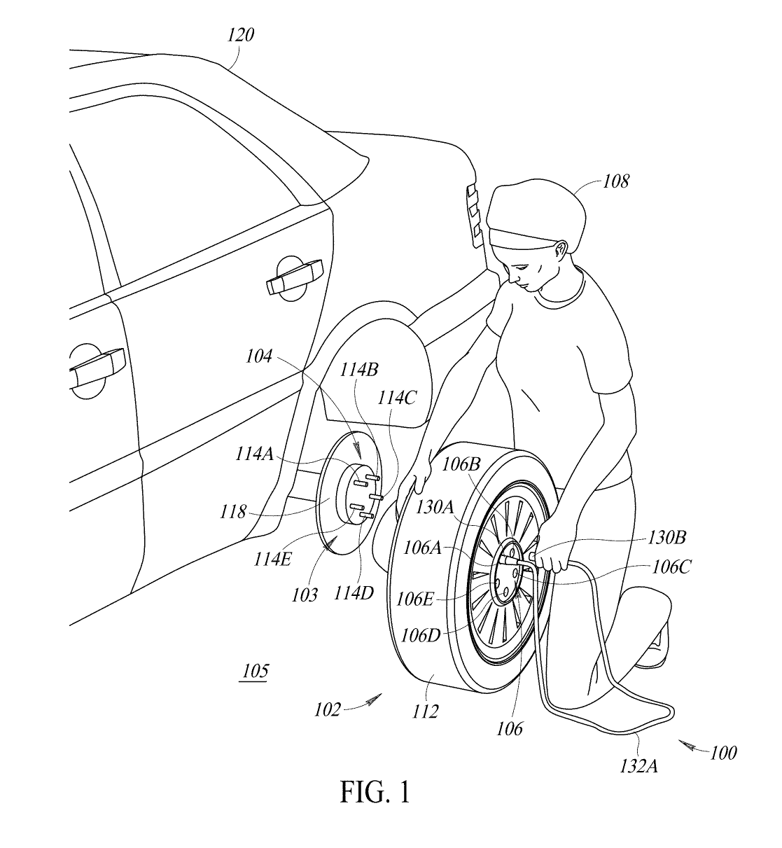

FIG. 1 illustrates a first embodiment of a mechanical guiding system 100 that may be used to guide a part 102 with respect to one or more desired positions 103. The part 102 has one or more through-holes 106 (e.g., wheel lug holes) configured to be aligned with the desired position(s) 103. The part 102 may be implemented as a wheel 112 or other component. In the example illustrated, the wheel 112 includes both a tire and a rim.

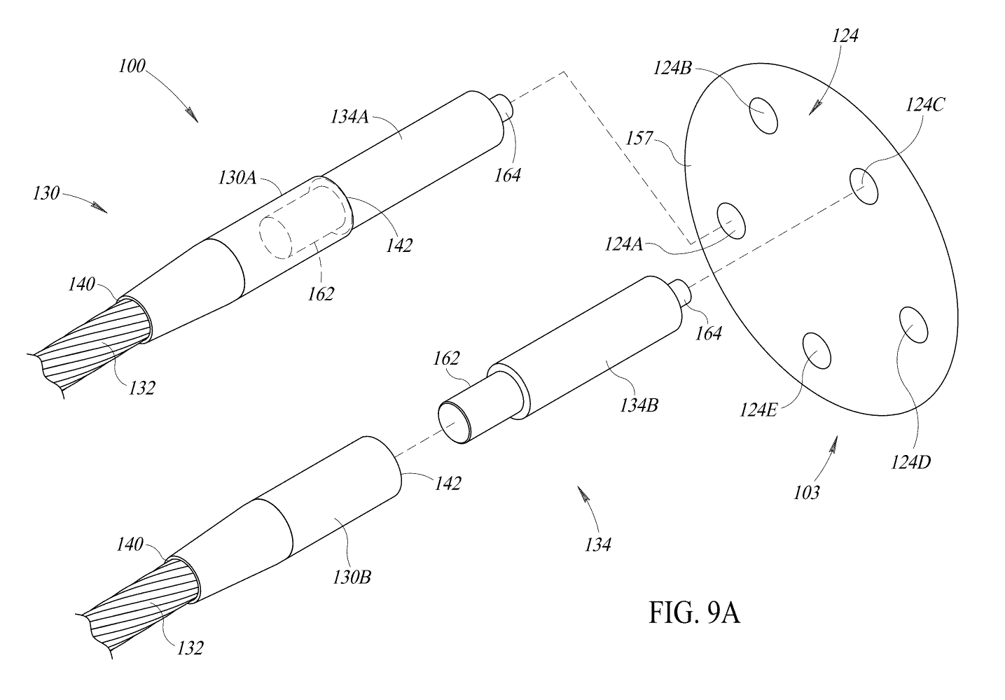

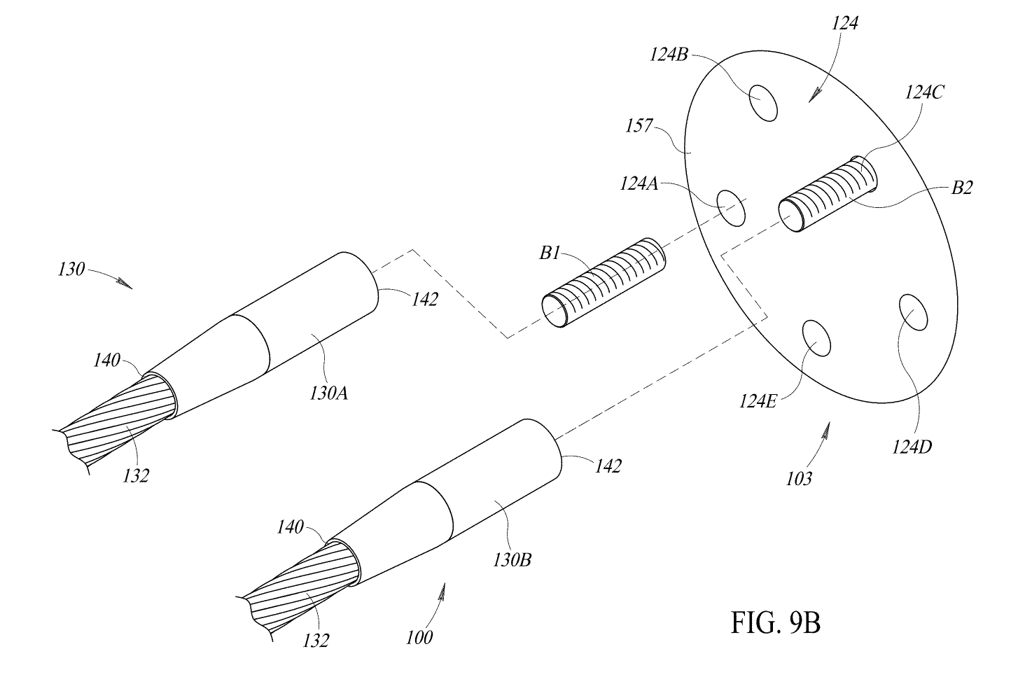

The desired position(s) 103 may be implemented as one or more generally horizontally oriented mounts 104 and/or one or more openings or holes 124 (see FIGS. 9A and 9B). The mount(s) 104 may extend outwardly from one or more objects (e.g., a wheel hub assembly 118, a disk, a drum, a plate, a surface, and the like). The mount(s) 104 may be implemented as lugs 114A-114E, one or more bolts, one or more pegs, one or more posts, one or more threads, one or more studs, and the like. The hole(s) 124 (see FIGS. 9A and 9B) may be formed in a disk, a drum, a plate, a surface, and the like.

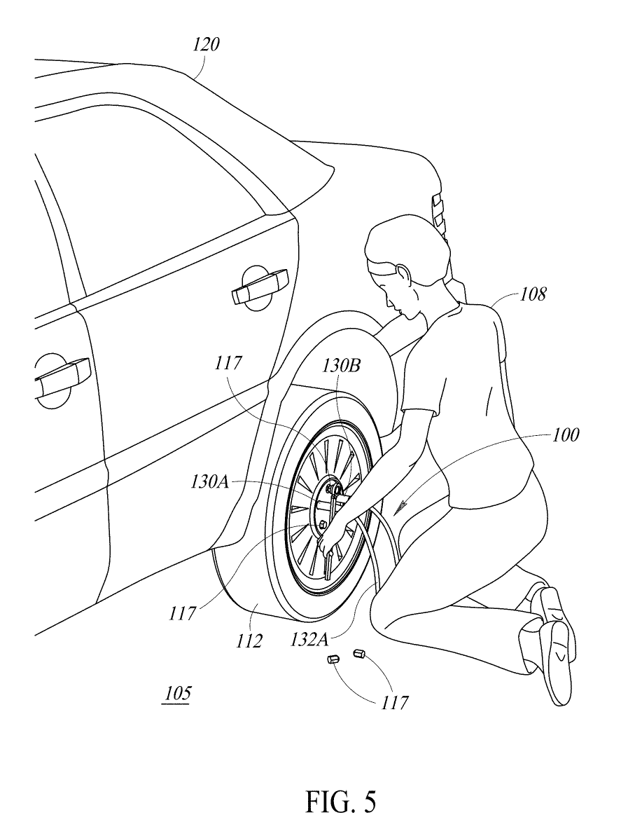

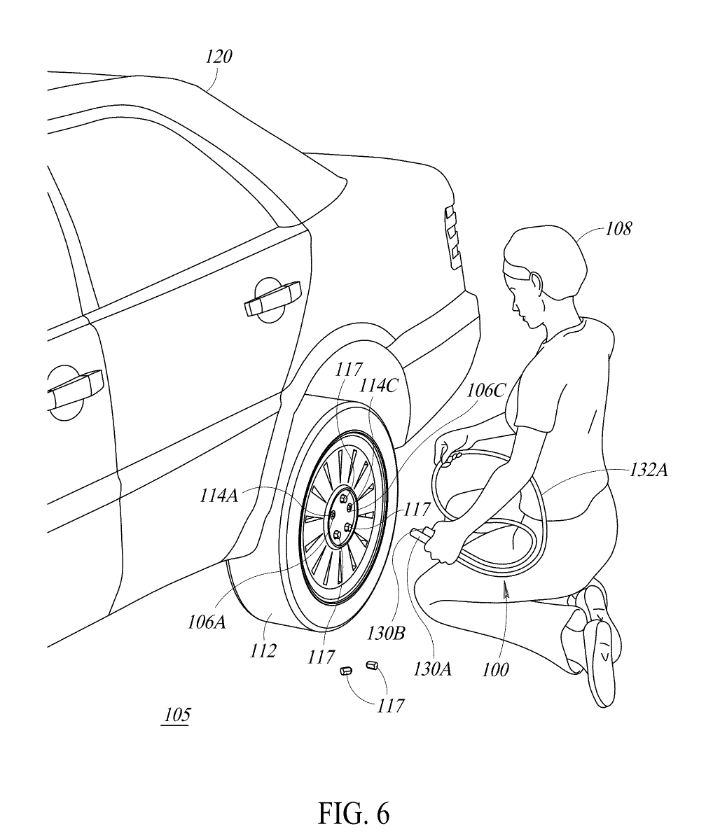

The system 100 may be used by a user 108 to lift and control the part 102 as the user 108 positions the through-hole(s) 106 relative to the desired position(s) 103. For example, the system 100 may be used to lift the part 102 from the ground 105 and position the part 102 onto the mount(s) 104. In the example illustrated, the part 102 is implemented as the wheel 112, which includes five through-holes 106A-106E configured to receive the five lugs 114A-114E, respectively. Thus, the through-holes 106A-106E may be characterized as corresponding to the lugs 114A-114E, respectively. The system 100 may be used by the user 108 to lift the wheel 112 and position the lugs 114A-114E in the through-holes 106A-106E, respectively, while the user 108 is in a bent or crouching position and trying to see the lugs 114A-114E through the through-holes 106A-106E. In the embodiment illustrated, each of the lugs 114A-114E includes outside threads 116 (see FIG. 8) configured to mate with inside threads (not shown) of a fastener 117 (see FIGS. 5 and 6). The fasteners 117 may each be implemented a lug nut.

For ease of illustration, the system 100 has been illustrated in FIGS. 1-6 and will be described as being used to guide the wheel 112 onto the lugs 114A-114E of the wheel hub assembly 118 or similar structure of a vehicle 120 (e.g., a car, a truck, a bus, etc.). However, the system 100 may be used to guide other types of parts with respect to other desired positions (e.g., onto other types of mounts). Further, the system 100 may be used to mount the wheel 112 on other structures. For example, the system 100 may be used to store the wheel 112 on bolts (not shown) installed on the back of the vehicle 120.

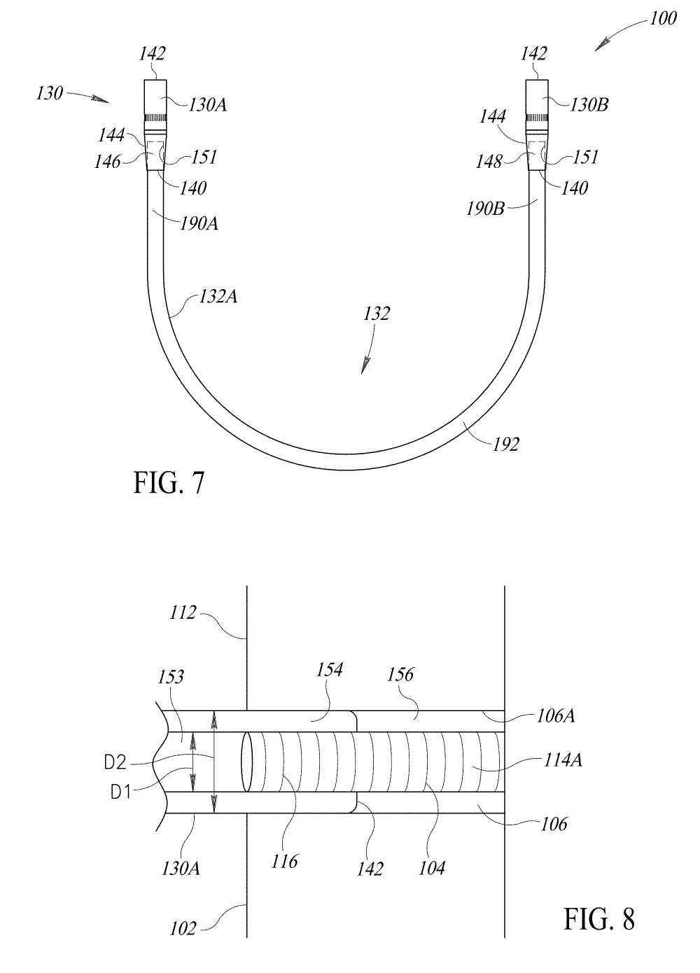

Referring to FIG. 7, the system 100 includes at least one connector 130 (e.g., connectors 130A and 130B) and at least one handle member 132 (e.g., a handle member 132A). Optionally, the system 100 may include one or more adapters 134 (see FIG. 9A).

Each of the connector(s) 130 may be configured to grip onto one of the desired position(s) 103 (see FIGS. 1, 2, 9A, 9B, and 15). For example, each of the connector(s) 130 may be configured to slide onto one of the mount(s) 104 (see FIG. 1), be threaded onto one of the mount(s) 104, clamp onto one of the mount(s) 104, be inserted into one of the hole(s) 124 (see FIGS. 9A and 9B), be threaded into one of the hole(s) 124, or otherwise grip onto one of the desired position(s) 103 (see FIGS. 1, 2, 9A, 9B, and 15). Each of the connector(s) 130 has a tethered proximal end 140 opposite a free distal end 142. Optionally, a tapered transition portion 144 tapers outwardly from the tethered proximal end 140 partway toward the free distal end 142.

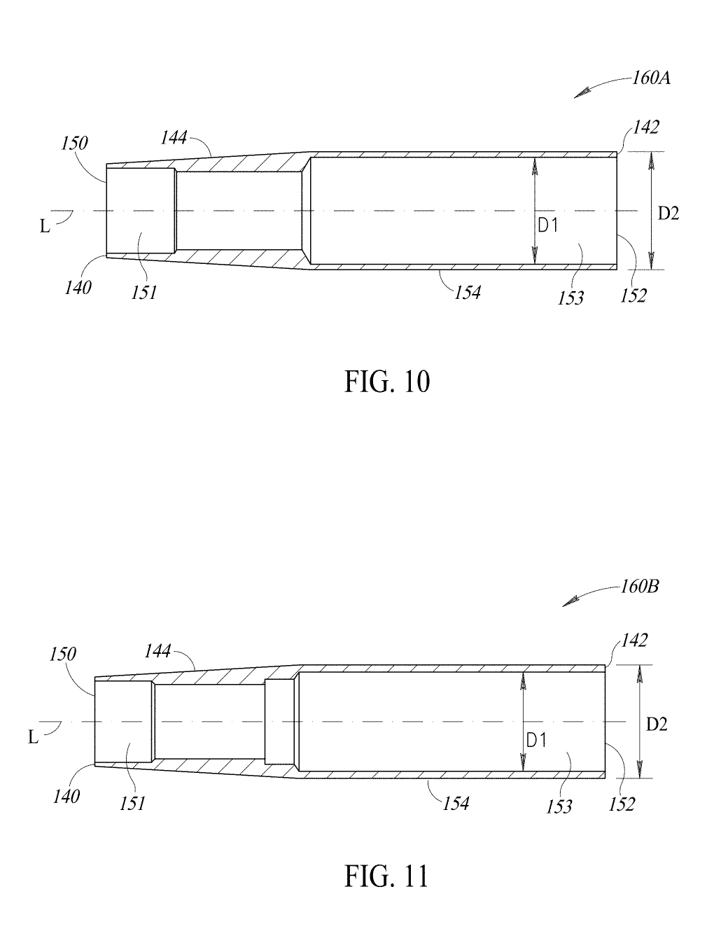

The tethered proximal end 140 of each of the connector(s) 130 is attached to one of the handle member(s) 132. In the embodiment illustrated in FIG. 7, the tethered proximal end 140 of each of the connectors 130A and 130B is attached to opposite end portions 146 and 148 of the same handle member 132A. Thus, in such embodiments, the handle member 132A couples the tethered proximal ends 140 of the connectors 130A and 130B together. Referring to FIGS. 10-12, the tethered proximal end 140 includes an opening 150 into a channel 151 that extends along a longitudinal axis L. Referring to FIG. 7, the channel 151 of the connector 130A is configured to receive the first end portion 146 of the handle member 132A through the opening 150 (see FIGS. 10-12) formed in the connector 130A. The channel 151 of the connector 130B is configured to receive the second end portion 148 of the handle member 132A through the opening 150 (see FIGS. 10-12) formed in the connector 130B. The first end portion 146 is permanently attached (e.g., by one or more bonding agents pinning, or pressing) to the inside of the channel 151 of the connector 130A and the second end portion 148 is permanently attached (e.g., by one or more bonding agents pinning, or pressing) to the inside of the channel 151 of the connector 130B.

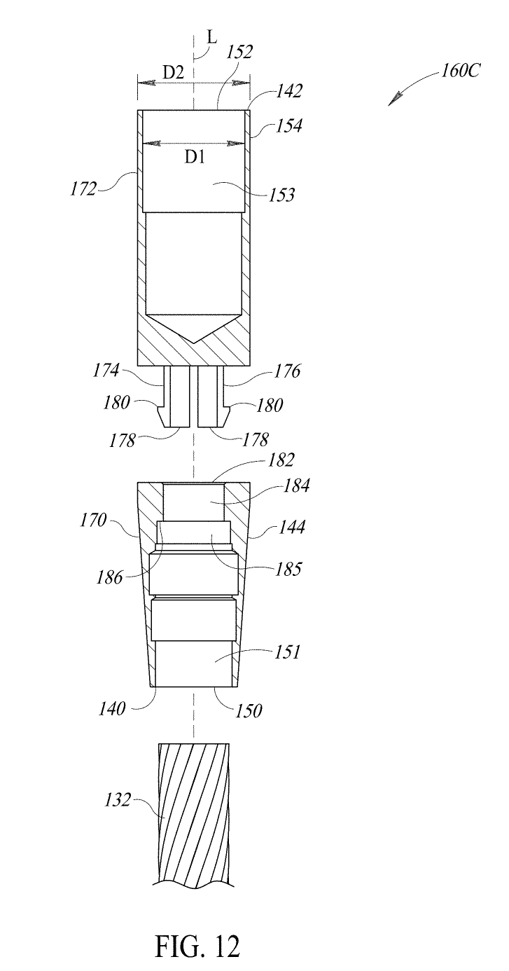

Each of the connector(s) 130 may be male or female depending upon the desired position(s) 103 (see FIGS. 1, 2, 9A, 9B, and 15). In the embodiment illustrated in FIG. 1, the system 100 includes the female connectors 130A and 130B each configured to receive and grip one of the lugs 114A-114E. For example, the free distal ends 142 (see FIGS. 7-14) of the connectors 130A and 130B may grip the lugs 114A and 114C, respectively. Referring to FIG. 10-12, in the embodiment illustrated, the free distal end 142 includes an opening 152 into a channel 153 that extends inwardly from the free distal end 142 along the longitudinal axis L. In the embodiments illustrated in FIGS. 10 and 11, the channel 153 is continuous with the channel 151. However, this is not a requirement. In alternate embodiments, such as the embodiment illustrated in FIG. 12, the channel 153 is discontinuous with the channel 151.

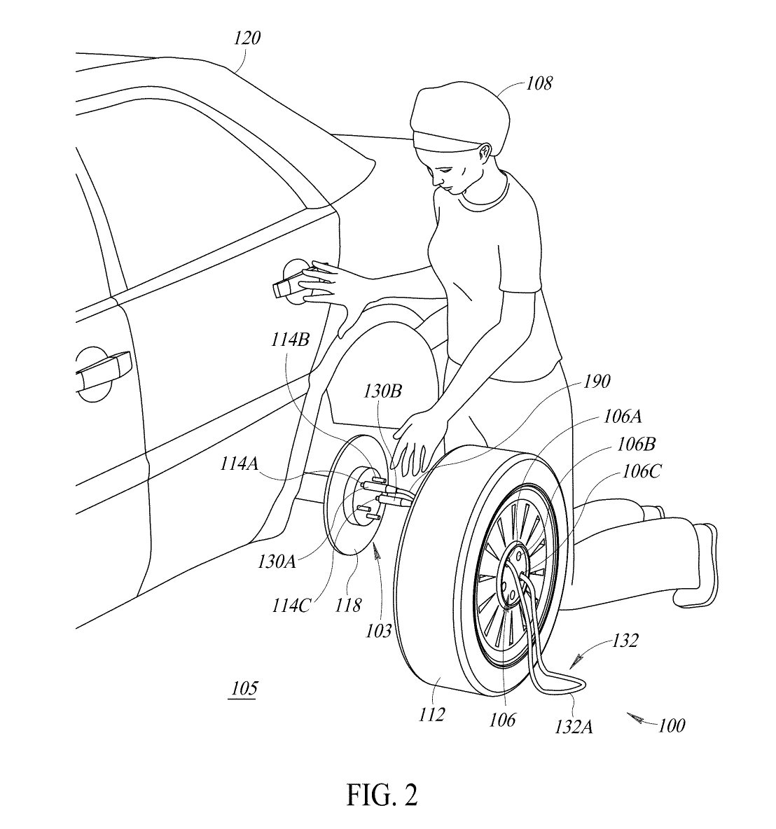

Referring to FIG. 10-12, the channel 153 is defined by a sidewall 154. The sidewall 154 has inside and outside dimensions D1 and D2 (e.g., diameters). The inside dimension D1 is large enough for the channel 153 to receive one of the lugs 114A-114E (see FIG. 1). For example, referring to FIG. 2, the free distal ends 142 (see FIGS. 7-14) of the connectors 130A and 130B may be slid or threaded onto the lugs 114A and 114C, respectively. By way of non-limiting examples, the inside dimension D1 may be 0.5 inches, 12 millimeter (“mm”), 13 mm, or 14 mm. Referring to FIG. 10-12, the outside dimension D2 is small enough to fit through one of the through-hole(s) 106 (see FIGS. 1, 2, and 8) of the part 102 (see FIGS. 1, 8, and 15). Thus, referring to FIG. 8, the sidewall 154 has a thickness (e.g., the outside dimension D2 minus the inside dimension D1) sized to fit within a gap 156 defined between one of the mount(s) 104 (e.g., the lug 114A) and one of the through-hole(s) 106 (e.g., the through-hole 106A) of the part 102 (e.g., the wheel 112).

Referring to FIGS. 9A and 9B, instead of the lugs 114A-114E (see FIG. 1), some wheel hub assemblies (e.g., a wheel hub assembly 157) include the hole(s) 124. Each of the hole(s) 124 may be other than circular. In the embodiment illustrated, the hole(s) 124 include holes 124A-124E. In such embodiments, the free distal end 142 of each of the connector(s) 130 may be male and configured to be inserted into the holes 124A-124E. Alternatively, the free distal ends 142 of the female connectors 130A and 130B may be small enough to be received inside the holes 124A and 124C, respectively.

By way of another non-limiting example, referring to FIG. 9A, the system 100 may include a different adapter 134 for each of the female connector(s) 130. For example, the system 100 may include two adapters 134A and 134B that each has a first end portion 162 opposite a second end portion 164. The first end portions 162 of the adapters 134A and 134B are configured to be inserted into the channels 153 (see FIGS. 8, 10-12, and 14) of the connectors 130A and 130B, respectively. The second end portions 164 of the adapters 134A and 134B are configured to be received into the topmost holes 124A and 124C, respectively. The hole 124B between the holes 124A and 124C may be skipped. Thus, the adapters 134A and 134B convert each of the female connectors 130A and 130B, respectively, into a male connector. The adapters 134A and 134B are removed from the holes 124A and 124C, respectively, after the female connectors 130A and 130B have been removed from the adapters 134A and 134B, respectively. Each of the adapter(s) 134 may have a single or multi-part construction.

By way of yet another non-limiting example, referring to FIG. 9B, the adapters 134A and 134B (see FIG. 9A) may be implemented as a pair of stud bolts B1 and B2 (e.g., about 2 inches to about 3 inches long). The stud bolts B1 and B2 may be inserted (e.g., threaded) into the topmost pair of holes 124A and 124C. The hole 124B between the holes 124A and 124C may be skipped. Then, the stud bolts B1 and B2 may be inserted into the channels 153 (see FIGS. 8, 10-12, and 14) of the connectors 130A and 130B, respectively. The stud bolts B1 and B2 are each sufficiently long enough to protrude through the wheel 112 so that they may be removed from the holes 124A and 124C, respectively, after the female connectors 130A and 130B have been removed from the stud bolts B1 and B2, respectively.

Each of the connector(s) 130 may be constructed from a suitable metal (e.g., stainless steel), polymer, and/or a composite. Each of the connector(s) 130 may have a satin outer finish. Each of the connector(s) 130 may be molded, slotted, flexible, or rigid. Each of the connector(s) 130 may be constructed (e.g., molded) as a single unit, or constructed from two or more subcomponents (e.g., by insertion, twisting, pressing, welding, pinning, threading, adhesion via one or more chemical compounds or bonding agents, and/or dimpling).

By of non-limiting examples, each of the connector(s) 130 may each be implemented as one of connectors 160A-160C illustrated in FIGS. 10-12, respectively. FIGS. 10 and 11 illustrate the example connectors 160A and 160B each are each molded as a single unit. In FIGS. 9A and 9B, the connectors 130A and 130B have been illustrated as being implemented as the connector 160A.

FIGS. 12-14 illustrate the example connector 160C, which is constructed from a proximal end component 170 and a distal end component 172. Referring to FIG. 12, the distal end component 172 includes the channel 153 and the sidewall 154. The proximal end component 170 includes the channel 151 and may include the tapered transition portion 144.

In the embodiment illustrated, the distal end component 172 is configured to snap inside the proximal end component 170 and to be rotatable relative to the proximal end component 170 about the longitudinal axis L. For example, the distal end component 172 may have a longitudinally extending pair of gripping projections 174 and 176. The gripping projections 174 and 176 may be spaced apart laterally and configured to deflect laterally toward one another. Each of the gripping projections 174 and 176 has a free end portion 178 and a laterally outwardly extending stop portion 180. The proximal end component 170 has an opening 182 into a channel 184. The opening 182 is narrower than the stop portions 180 of the gripping projections 174 and 176. Pushing the gripping projections 174 and 176 into the opening 182 causes them to deflect toward one another and allow the stop portions 180 to pass into the channel 184. The channel 184 is continuous with a wider channel 185. A shoulder 186 is defined between the wider channel 185 and the channel 184. When the stop portions 180 pass from the channel 184 into the wider channel 185, the gripping projections 174 and 176 are allowed to move apart from one another. This allows the stop portions 180 to engage the shoulder 186, which prevents the distal end component 172 from being separated from the proximal end component 170. However, the distal end component 172 is allowed to rotate with respect to the proximal end component 170 about the longitudinal axis L. In the embodiment illustrated, the wider channel 185 is continuous with the channel 151. However, this is not a requirement.

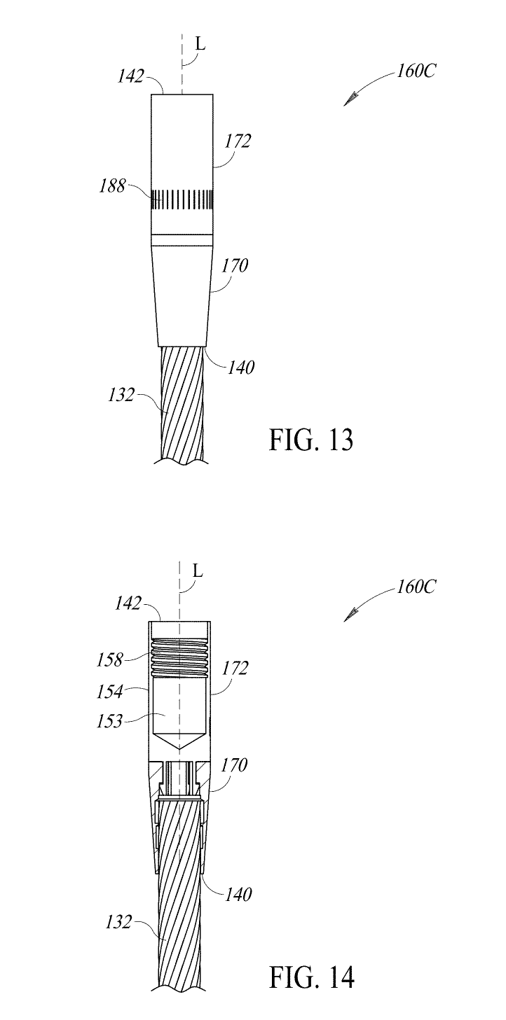

Optionally, referring to FIG. 14, the sidewall 154 may include inside threads 158 configured to mate with the outside threads 116 (see FIG. 8) of one of the lugs 114A-114E. Alternatively, the sidewall 154 may include may include one or more ridges (not shown) or other gripping projections (not shown) configured to grab onto the outside threads 116 (see FIG. 8) and help maintain the connector 160C temporarily attached to one of the lugs 114A-114E. Optionally, referring to FIG. 13, a textured surface and/or knurling 188 may extend circumferentially around the distal end component 172 and aid with threading the distal end component 172 onto one of the lugs 114A-114E (see FIG. 1).

Referring to FIG. 2, each of the handle member(s) 132 has a portion 190 configured to extend through one of the through-hole(s) 106. Referring to FIG. 7, the handle member 132A has first and second portions 190A and 190B each configured to extend through one of the through-hole(s) 106 (see FIGS. 1, 2, and 8). The first portion 190A is connected to the first end portion 146 and the second portion 190B is connected to the second end portion 148.

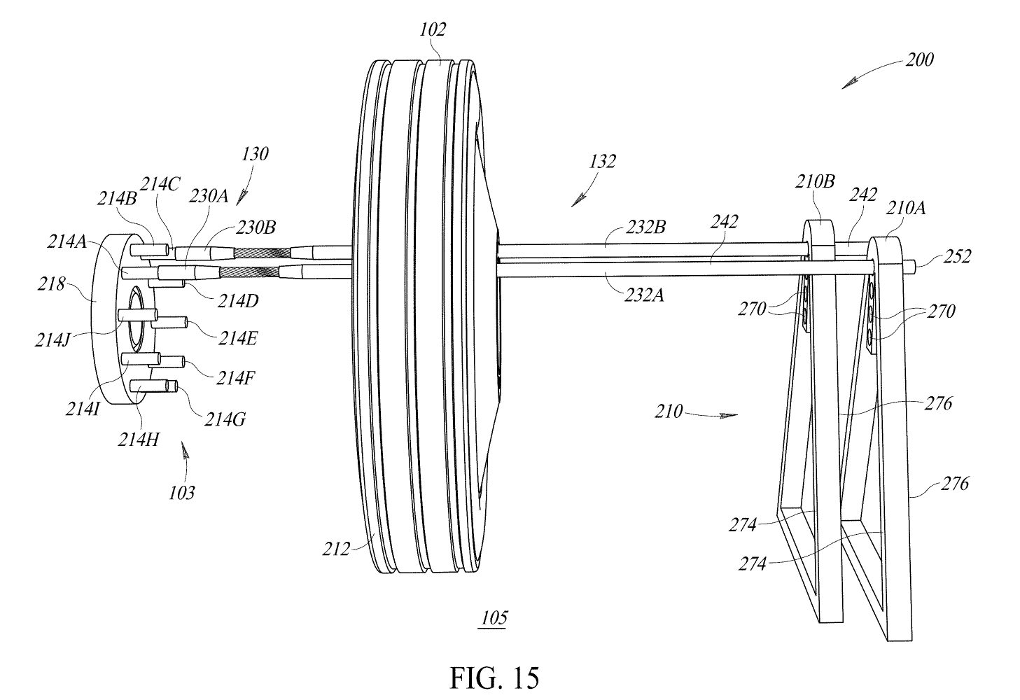

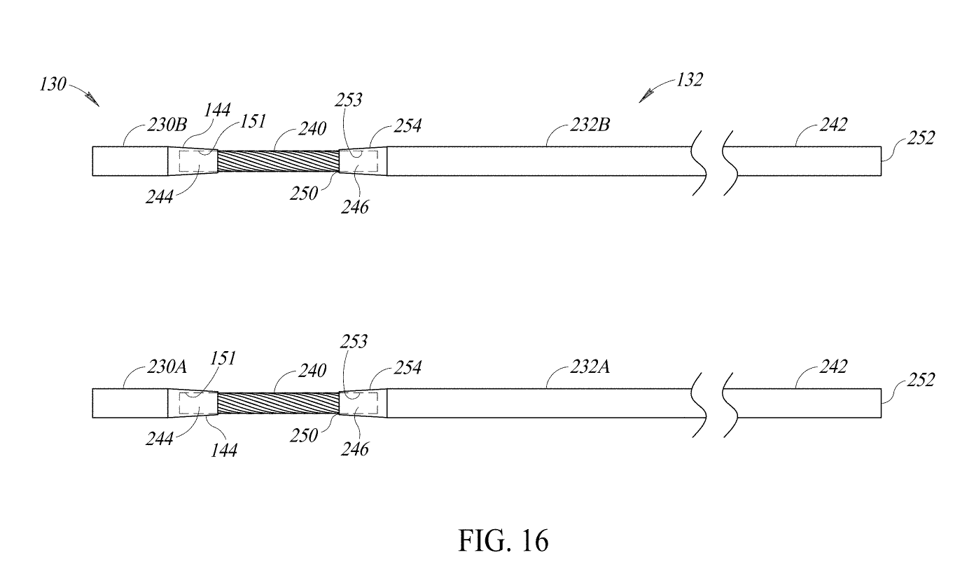

By way of non-limiting examples, each of the handle member(s) 132 may be implemented as a cable 192, a lever, a handle (e.g., one of handle members 232A and 232B illustrated in FIGS. 15 and 16), and the like. The handle member(s) 132 may each be constructed from flexible and/or rigid materials. The handle member(s) 132 may each be configured for a particular application, purpose, or use. For example, the handle member(s) 132 may each have a length, shape, dimension, and size configured to suit a particular use. By way of a non-limiting example, the handle member 132A may be implemented as a steel cable optionally wrapped in flexible cable jacket (e.g., constructed of plastic, rubber, nylon, and/or another material).

Optionally, one or more adhesive chemical compounds or bonding agents (not shown) may be used to attach each of the connector(s) 130 to one of the handle member(s) 132. The bonding agent(s) (not shown) may be configured for use with a wide range of openings. The bonding agent(s) (not shown) may be configured for use with a wide range of uses, including customized applications. Alternatively, pinning, threading, and the like may be used to attach each of the connector(s) 130 to one of the handle member(s) 132.

As mentioned above, referring to FIG. 1, the system 100 may be used to align the part 102 with respect to the desired position(s) 103. FIGS. 1-6 illustrate the system 100 being used to install the wheel 112 on the lugs 114A-11E (e.g., when changing a tire on the vehicle 120). Referring to FIG. 1, after the vehicle 120 has been lifted above the ground 105 and the wheel hub assembly 118 has been exposed (e.g., by removing the flat or damaged tire and rim), the wheel 112 is moved into position next to the wheel hub assembly 118. Then, the connectors 130A and 130B are fed through the through-hole 106A and 106C, respectively. In this example, the through-hole 106B between the through-hole 106A and 106C may be skipped. Next, referring to FIG. 2, the connectors 130A and 130B are attached to the lugs 114A and 114C, respectively. The lugs 114A and 114C correspond to the through-hole 106A and 106C, respectively, through which the connectors 130A and 130B, respectively, have been inserted. Thus, in this example, the lug 114B between the lugs 114A and 114C has been skipped. The connectors 130A and 130B may be pushed onto the lugs 114A and 114C, respectively. Alternatively, the connectors 130A and 130B may be threaded onto the lugs 114A and 114C, respectively. By way of another non-limiting example, the connectors 130A and 130B may each include a strong magnet configured to hold onto the lugs 114A and 114C, respectively.

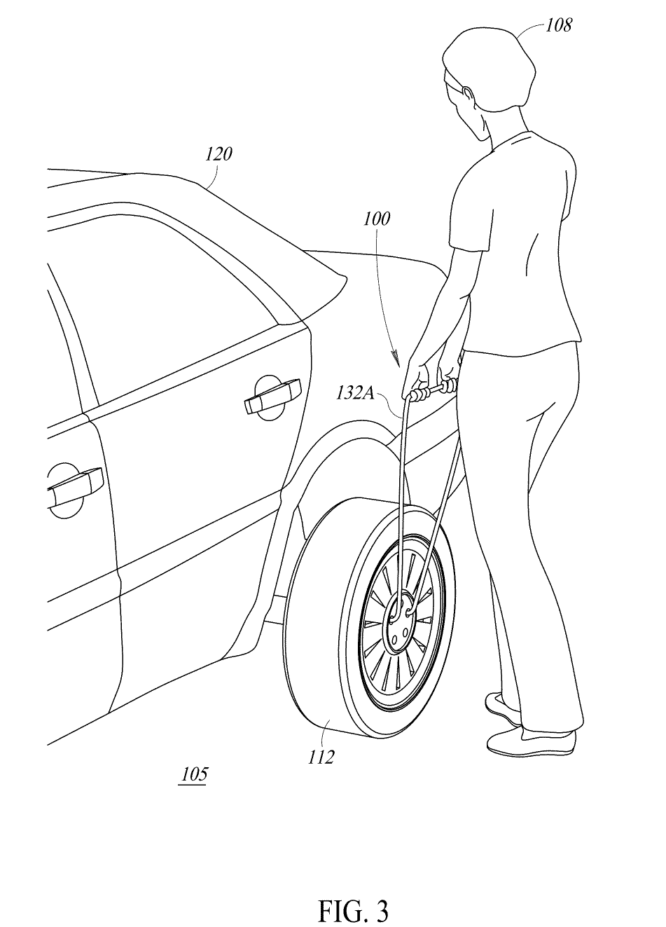

Referring to FIG. 3, after the connectors 130A and 130B (see FIGS. 1, 2, 4-7, 9A, and 9B) have been connected to the lugs 114A and 114C (see FIGS. 1, 2, and 6), respectively, the wheel 112 is free to slide along the handle member 132A. The user 108 lifts upwardly on the handle member 132A (using one or both hands) and lifts the wheel 112 up off the ground 105.

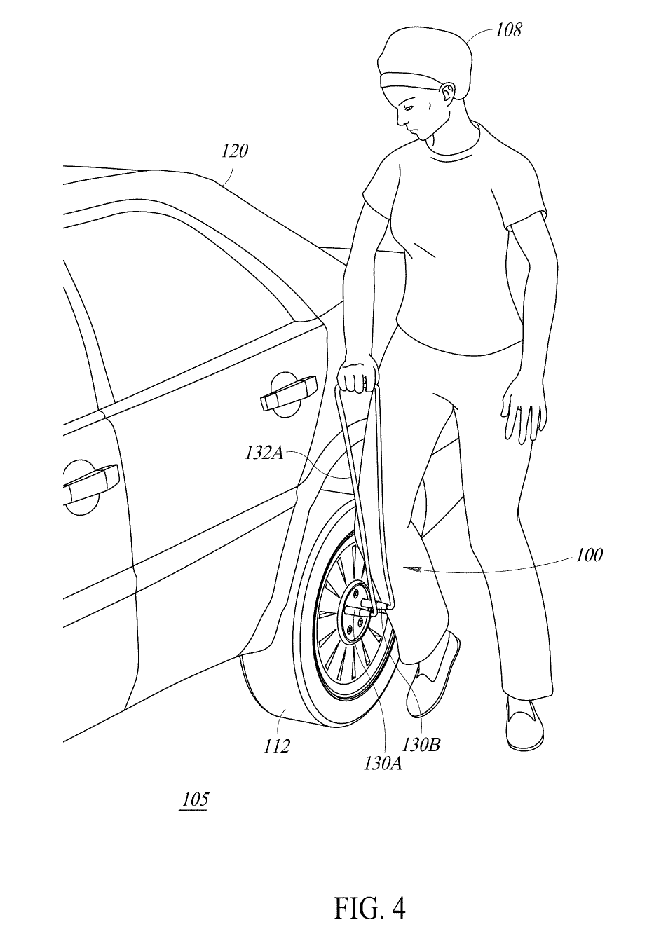

Referring to FIG. 4, the wheel 112 slides along the handle member 132A and into position on the connectors 130A and 130B, which are attached to the lugs 114A and 114C (see FIGS. 1, 2, and 6), respectively. The user 108 may push the wheel 112 into place on the connectors 130A and 130B. As shown in FIG. 4, the user 108 may use his/her leg to push the wheel 112 into place.

Then, referring to FIG. 5, the user 108 may at least partially install the fastener 117 (e.g., a lug nut) onto at least one of the lugs 114B, 114D, and 114E (see FIG. 1) to which the connectors 130A and 130B are not attached. Each fastener 117 is inserted into one of the through-holes 106B, 106D, and 106E (see FIG. 1) and attaches the wheel 112 to the wheel hub assembly 118 (see FIGS. 1 and 2). At this point, while the fastener(s) 117 may not be fully tightened, the wheel 112 is supported fully by the lugs 114A-114E (see FIG. 1).

Referring to FIG. 6, the user 108 removes (e.g., unthread) the connectors 130A and 130B from the lugs 114A and 114C, respectively. Then, the user 108 installs the fasteners 117 on the lugs 114A and 114C. The user 108 also installs the fasteners 117 on any of the lugs 114B, 114D, and 114E on which fasteners were not previously installed. At this point, the user 108 may tighten the fasteners 117 in accordance with manufacturer suggestions (e.g., using a wrench). Thus, the user 108 secures the wheel 112 to the wheel hub assembly 118 (see FIGS. 1 and 2) using the fasteners 117. If the vehicle 120 is lifted above the ground 105, the user 108 may lower the vehicle 120 to the ground 105. Finally, tools (e.g., the system 100) and other parts may be collected and stowed.

As mentioned above, referring to FIG. 9A, instead of the lugs 114A-114E, the desired position(s) 103 may be the holes 124A-124E. In such embodiments, after the wheel 112 (see FIGS. 1-6 and 8) has been slid into position on the connectors 130A and 130B (and optionally the adapters 134A and 134B or the stud bolts B1 and B2 illustrated in FIG. 9B), the user 108 (see FIGS. 1-6) can install wheel bolts (not shown) into the holes 124B, 124D, and 124E and tighten them slightly. Then, the user 108 can remove the connectors 130A and 130B. If the adapters 134A and 134B were used, they may be removed from the holes 124A and 124C, respectively. Referring to FIG. 9B, if the stud bolts B1 and B2 were used, they may be removed from the holes 124A and 124C, respectively. Next, the user 108 can install wheel bolts (not shown) in the holes 124A and 124C and in any of the holes 124B, 124D, and 124E in which wheel bolts (not shown) were not previously installed. At this point, referring to FIG. 6, the user 108 can tighten all of the wheel bolts (not shown) before lowering the vehicle 120 to the ground 105. Finally, tools (e.g., the system 100) and other parts may be collected and stowed.

### Alternate Embodiment

FIG. 15 illustrates a second embodiment of a mechanical guiding system 200. The system 200 may be used when the part 102 is larger and/or heavier than a standard automobile tire and rim. For example, the system 200 may be used with heavier wheels or parts. Like the system 100 (see FIGS. 1-7, 9A, and 9B), the system 200 may be used to lift the part 102 (e.g., a wheel 212) and guide the part 102 toward the desired position(s) 103. In the embodiment illustrated, the desired position(s) 103 have been implemented as ten lugs 214A-214J of a wheel hub assembly 218.

Like the system 100 (see FIGS. 1-7, 9A, and 9B), the system 200 includes the connector(s) 130 and the handle member(s) 132. Optionally, the system 200 may include one or more stabilizers or stands 210. Optionally, the system 200 may include a different adapter 134 (see FIG. 9A) for each of the connector(s) 130. In the embodiment illustrated, the connector(s) 130 include connectors 230A and 230B and the handle member(s) 132 include the two handle members 232A and 232B connected to the connectors 230A and 230B, respectively.

The connectors 230A and 230B are substantially similar to the connectors 130A and 130B (see FIGS. 1, 2, 4-7, 9A, and 9B) and may be constructed using any method and/or material suitable for constructing the connectors 130A and 130B. The connectors 230A and 230B are configured to be inserted through the through-holes 106A and 106C (see FIGS. 1, 2, and 6), respectively, of the part 102. In the embodiment illustrated, the connectors 230A and 230B are female and configured to receive the lugs 214A and 214C, respectively. However, in alternate embodiments, the connectors 230A and 230B may be male.

Referring to FIG. 16, the each of the handle members 232A and 232B may include an intermediate flexible portion 240 (e.g., a section of cable) connected to a rigid handle portion 242. The intermediate flexible portion 240 is configured to pass through one of the through-hole(s) 106 (see FIGS. 1, 2, and 8). The intermediate flexible portions 240 may provide stress and/or strain relief to the rigid handle portions 242 of the handle members 232A and 232B. The intermediate flexible portion 240 has a first end portion 244 opposite a second end portion 246. The first end portions 244 of the intermediate flexible portions 240 of the handle members 232A and 232B are attached (e.g., by a chemical bonding agent, pinning, or pressing) to the connectors 230A and 230B, respectively, inside their channels 151. The first end portions 244 may be permanently attached (e.g., by one or more bonding agents, pinning, or pressing) to the inside of the channel 151 in the same manner that the first end portion 146 (see FIG. 7) of the handle member 132A (see FIGS. 1-7) may be permanently attached to the inside of the channel 151 of the connector 130A (see FIGS. 1, 2, and 4-9B).

The second end portions 246 of the intermediate flexible portions 240 of the handle members 232A and 232B are attached to the rigid handle portions 242 of the handle members 232A and 232B, respectively. The rigid handle portions 242 each have a tethered proximal end portion 250 opposite a free distal end 252. The tethered proximal end portion 250 is connected to the intermediate flexible portion 240 and is configured to pass through one of the through-hole(s) 106 (see FIGS. 1, 2, and 8). The tethered proximal end portion 250 includes a channel 253 configured to receive the second end portion 246 of the intermediate flexible portion 240. The second end portion 246 is permanently attached (e.g., by one or more bonding agents, pinning, or pressing) to the inside of the channel 253. The first end portion 244 may be permanently attached (e.g., by one or more bonding agents pinning, or pressing) to the inside of the channel 253 in the same manner that the first end portion 244 may be permanently attached to the inside of the channel 151.

Optionally, each of the rigid handle portions 242 may include a tapered transition portion 254 that tapers outwardly from the tethered proximal end portion 250 partway toward the free distal end 252. The tapered transition portion 254 may be substantially identical to the tapered transition portion 144.

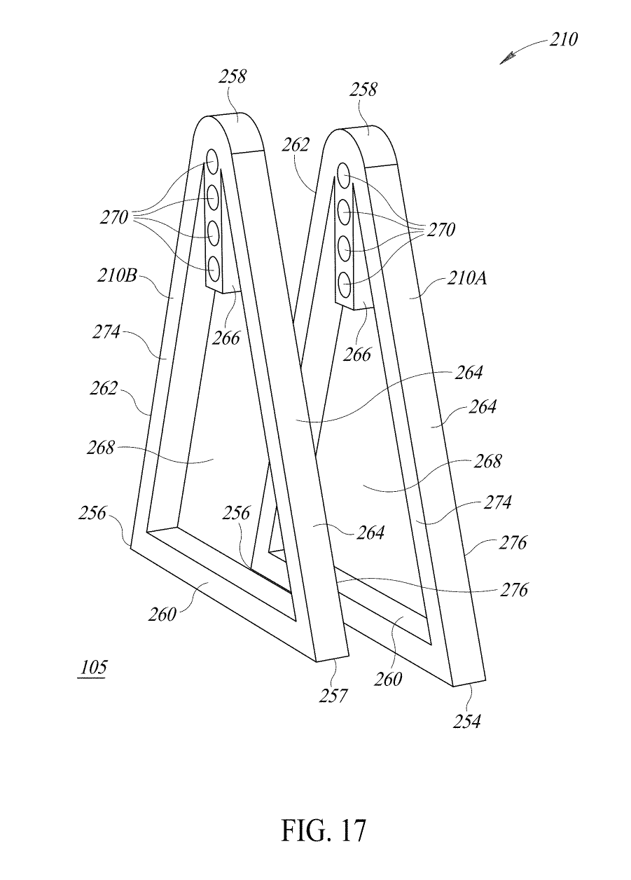

Referring to FIGS. 15 and 17, the stand(s) 210 may be implemented as a pair of stands 210A and 210B. The stands 210A and 210B may be substantially identical to one another. In the embodiment illustrated in FIGS. 15 and 17, the stands 210A and 2106 each has a generally triangular outer shape. Thus, referring to FIG. 17, the stands 210A and 210B each include three corners 256-258 interconnected by three support members 260, 262, and 264. The base support member 260 rests upon the ground 105 and the angled support members 262 and 264 each extend upwardly from the base support member 260. The first angled support member 262 is connected to the base support member 260 at the first corner 256 and the second angled support member 264 is connected to the base support member 260 at the second corner 257. The angled support members 262 and 264 extend toward one another and are connected together at the third corner 258. The third corner 258 is positioned above the base support member 260.

A mounting member 266 extends downwardly from the third corner 258 toward the base support member 260 and into an open area 268 defined by the support members 260, 262, and 264. The mounting member 266 includes a series of mounting slots or holes 270. In the embodiment illustrated, the mounting holes 270 are arranged linearly (e.g., along a vertical line) and are each positioned at a different height. The mounting holes 270 may extend partway or completely through the mounting member 266. In the embodiment illustrated, the mounting holes 270 have been implemented as through-holes.

Referring to FIG. 15, each of the mounting holes 270 (see FIG. 17) of the stand 210A is configured to receive the free distal end 252 of the rigid handle portion 242 of the handle member 232A and to allow the rigid handle portion 242 of the handle member 232A to pass therethrough. Similarly, each of the mounting holes 270 of the stand 210B is configured to receive the free distal end 252 of the rigid handle portion 242 of the handle member 232B and to allow the rigid handle portion 242 of the handle member 232B to pass therethrough.

A first height of the handle member 232A with respect to the part 102 is determined by into which one of the mounting holes 270 of the stand 210A the rigid handle portion 242 of the handle member 232A is inserted. Thus, a selection of one of the mounting holes 270 of the stand 210A determines the first height. Similarly, a second height of the handle member 232B with respect to the part 102 is determined by into which one of the mounting holes 270 of the stand 210B the rigid handle portion 242 of the handle member 232B is inserted. Thus, a selection of one of the mounting holes 270 of the stand 210B determines the first height.

Optionally, the stand(s) 210 may include reflective material. In such embodiments, the stand(s) 210 may be used (e.g., during an emergency) as a reflective marker. By way of a non-limiting example, the stands 210A and 210B may each include front and rear surfaces 274 and 276. Reflective material (e.g., reflective tape) may be positioned along at least one of the front and rear surfaces 274 and 276. The user 108 (see FIGS. 1-6) may face one of the surfaces 274 and 276 of one or both of the stands 210A and 210B toward oncoming traffic. Optionally, the user 108 (see FIGS. 1-6) may insert the handle member 232A into one of the mounting holes 270 of the stand 210A and use the handle member 232A to prop up the stand 210A before facing one of the surfaces 274 and 276 toward the oncoming traffic. Similarly, the user 108 (see FIGS. 1-6) may insert the handle member 232B into one of the mounting holes 270 of the stand 210B and use the handle member 232B to prop up the stand 210B before facing one of the surfaces 274 and 276 toward the oncoming traffic.

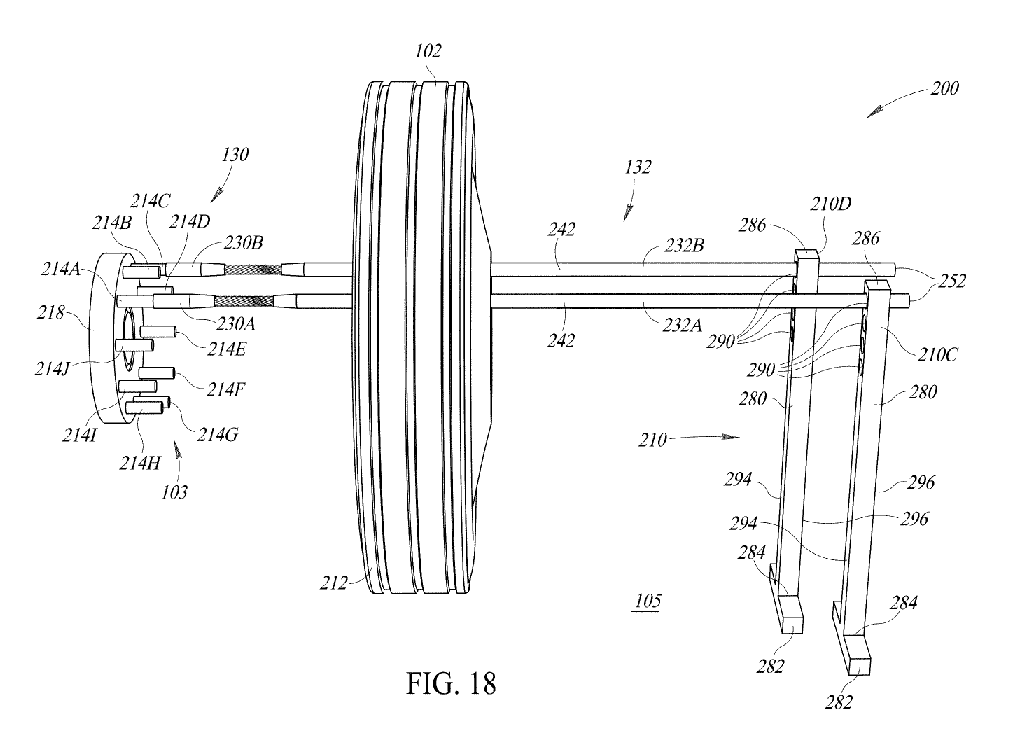

Alternatively, referring to FIG. 18, the stand(s) 210 may be implemented as a pair of stands 210C and 210D. The stands 210C and 210D may be substantially identical to one another. In the embodiment illustrated in FIG. 18, the stands 210C and 210D are each generally T-shaped. Thus, the stands 210C and 210D each include a base support member 280 configured to rest upon the ground 105 and an upright support member 282 that extends upwardly from the base support member 280. The upright support member 282 has a tethered end 284 opposite a free distal end 286. The tethered end 284 is connected to the base support member 280 at near a center of the base support member 280.

Near the free distal end 286, the upright support member 282 includes a series of mounting slots or holes 290. In the embodiment illustrated, the mounting holes 290 are arranged linearly (e.g., along a vertical line) and are each positioned at a different height. The mounting holes 290 may extend partway or completely through the upright support member 282. In the embodiment illustrated, the mounting holes 290 have been implemented as through-holes. Each of the mounting holes 290 of the stand 210C is configured to receive the free distal end 252 of the rigid handle portion 242 of the handle member 232A and to allow the rigid handle portion 242 of the handle member 232A to pass therethrough. Similarly, each of the mounting holes 290 of the stand 210D is configured to receive the free distal end 252 of the rigid handle portion 242 of the handle member 232B and to allow the rigid handle portion 242 of the handle member 232B to pass therethrough.

A third height of the handle member 232A with respect to the part 102 is determined by into which one of the mounting holes 290 of the stand 210C the rigid handle portion 242 of the handle member 232A is inserted. Thus, a selection of one of the mounting holes 290 of the stand 210C determines the third height. Similarly, a fourth height of the handle member 232B with respect to the part 102 is determined by into which one of the mounting holes 290 of the stand 210D the rigid handle portion 242 of the handle member 232B is inserted. Thus, a selection of one of the mounting holes 290 of the stand 210D determines the fourth height.

Optionally, as mentioned above, the stand(s) 210 may include reflective material. For example, the stands 210C and 210D may be used (e.g., during an emergency) as a reflective marker. By way of a non-limiting example, the stands 210C and 210D may each include front and rear surfaces 294 and 296. Reflective material (e.g., reflective tape) may be positioned along at least one of the front and rear surfaces 294 and 296. The user 108 (see FIGS. 1-6) may face one of the surfaces 294 and 296 of one or both of the stands 210C and 210D toward oncoming traffic. Optionally, the user 108 (see FIGS. 1-6) may insert the handle member 232A into one of the mounting holes 290 of the stand 210C and use the handle member 232A to prop up the stand 210C before facing one of the surfaces 294 and 296 toward the oncoming traffic. Similarly, the user 108 (see FIGS. 1-6) may insert the handle member 232B into one of the mounting holes 290 of the stand 210D and use the handle member 232B to prop up the stand 210D before facing one of the surfaces 294 and 296 toward the oncoming traffic.

Referring to FIG. 15, the handle members 232A and 232B are configured to be lifted (e.g., by the user 108 illustrated in FIGS. 1-6) after the connectors 230A and 230B have been attached to the lugs 214A and 214C, respectively. Lifting the handle members 232A and 232B lifts the wheel 212 off the ground 105. The handle members 232A and 232B function as levers providing mechanical advantage and helping the user 108 (see FIGS. 1-6) lift the wheel 212.

When the wheel 212 is lifted off the ground 105, the handle members 232A and 232B may be inserted into a pair of the mounting holes 270 of the stands 210A and 210B, respectively. Thus, the handle members 232A and 232B are lifted onto the stands 210A and 210B. The stands 210A and 210B hold the wheel 212 above the ground 105 and allow the wheel 212 to be slid along the handle members 232A and 232B and onto the lugs 214A-214E.

Alternatively, when the wheel 212 is lifted off the ground 105, the handle members 232A and 232B may be inserted into a pair of the mounting holes 290 of the stands 210C and 210D, respectively. Thus, the handle members 232A and 232B are lifted onto the stands 210C and 210D. In such embodiments, the stands 210C and 210D hold the wheel 212 above the ground 105 and allow the wheel 212 to be slid along the handle members 232A and 232B and onto the lugs 214A-214E.

Then, the user 108 may slide the wheel 212 onto the connectors 230A and 230B and the lugs 214B and 214D-214J. Next, the user 108 (see FIGS. 1-6) may at least partially install the fastener 117 (see FIGS. 5 and 6) onto at least one of the lugs 214B and 214D-214J to which the connectors 230A and 230B are not attached. The fastener(s) 117 attach the wheel 212 to the wheel hub assembly 218. At this point, while the fastener(s) 117 may not be fully tightened, the wheel 212 is supported fully by the lugs 214A-214J.

Then, the user 108 (see FIGS. 1-6) removes (e.g., unthreads) the connectors 230A and 230B from the lugs 214A and 214C, respectively, and installs the fasteners 117 on the lugs 214A and 214C. The user 108 also installs the fasteners 117 on any of the lugs 214B and 214D-214J on which fasteners were not previously installed. At this point, the user 108 may tighten the fasteners 117 in accordance with manufacturer suggestions. If the stands 210A and 210B were used, the user 108 (see FIGS. 1-6) removes the handle members 232A and 232B from the stands 210A and 210B. If the stands 210C and 210D were used, the user 108 (see FIGS. 1-6) removes the handle members 232A and 232B from the stands 210C and 210D. If the vehicle 120 (see FIGS. 1-6) is lifted above the ground 105, the user 108 may lower the vehicle 120 to the ground 105. Finally, tools (e.g., the system 200) and other parts may be collected and stowed.

The foregoing described embodiments depict different components contained within, or connected with, different other components. It is to be understood that such depicted architectures are merely exemplary, and that in fact many other architectures can be implemented which achieve the same functionality. In a conceptual sense, any arrangement of components to achieve the same functionality is effectively “associated” such that the desired functionality is achieved. Hence, any two components herein combined to achieve a particular functionality can be seen as “associated with” each other such that the desired functionality is achieved, irrespective of architectures or intermedial components. Likewise, any two components so associated can also be viewed as being “operably connected,” or “operably coupled,” to each other to achieve the desired functionality.

While particular embodiments of the present invention have been shown and described, it will be obvious to those skilled in the art that, based upon the teachings herein, changes and modifications may be made without departing from this invention and its broader aspects and, therefore, the appended claims are to encompass within their scope all such changes and modifications as are within the true spirit and scope of this invention. Furthermore, it is to be understood that the invention is solely defined by the appended claims. It will be understood by those within the art that, in general, terms used herein, and especially in the appended claims (e.g., bodies of the appended claims) are generally intended as “open” terms (e.g., the term “including” should be interpreted as “including but not limited to,” the term “having” should be interpreted as “having at least,” the term “includes” should be interpreted as “includes but is not limited to,” etc.). It will be further understood by those within the art that if a specific number of an introduced claim recitation is intended, such an intent will be explicitly recited in the claim, and in the absence of such recitation no such intent is present. For example, as an aid to understanding, the following appended claims may contain usage of the introductory phrases “at least one” and “one or more” to introduce claim recitations. However, the use of such phrases should not be construed to imply that the introduction of a claim recitation by the indefinite articles “a” or “an” limits any particular claim containing such introduced claim recitation to inventions containing only one such recitation, even when the same claim includes the introductory phrases “one or more” or “at least one” and indefinite articles such as “a” or “an” (e.g., “a” and/or “an” should typically be interpreted to mean “at least one” or “one or more”); the same holds true for the use of definite articles used to introduce claim recitations. In addition, even if a specific number of an introduced claim recitation is explicitly recited, those skilled in the art will recognize that such recitation should typically be interpreted to mean at least the recited number (e.g., the bare recitation of “two recitations,” without other modifiers, typically means at least two recitations, or two or more recitations).

Accordingly, the invention is not limited except as by the appended claims.

The invention claimed is:

1. A system for use with a part comprising a through-hole, the system comprising:
a connector configured to be removably attached to a desired position, the connector being configured to pass through the through-hole; and
a handle member having a distal portion connected to the connector, the distal portion being configured to pass through the through-hole, the handle member being configured to lift the part while the connector is attached to the desired position and a portion of the handle member is within the through-hole, the handle member being configured to allow the part to slide therealong and into the desired position while the part is lifted by the handle member, the connector being removable from the desired position after the part has been slid into the desired position.

2. The system of claim 1, wherein the desired position is a mount and the connector comprises a channel configured to receive the mount.

3. The system of claim 2 for use with the part being a wheel, wherein the mount is a lug.

4. The system of claim 3, wherein the lug comprises outside threads, and the connector comprises inside threads configured to engage the outside threads of the lug.

5. The system of claim 1, wherein the desired position is an opening and the connector comprises an end portion configured to be received by the opening.

6. The system of claim 1, wherein the distal portion is a flexible portion and the handle member comprises a rigid portion connected to the flexible portion.

7. The system of claim 1, wherein the handle member is a cable.

8. A system for use with a part comprising a plurality of through-holes, the system comprising:
a first connector configured to be removably attached to a first one of a plurality of desired positions, the first connector being configured to pass through a first one of the plurality of through-holes;
a second connector configured to be removably attached to a second one of the plurality of desired positions, the second connector being configured to pass through a second one of the plurality of through-holes; and
a handle member having a first portion connected to the first connector and a second portion connected to the second connector, the first and second portions being configured to pass through the first and second through-holes, respectively, the handle member being configured to lift the part while the first and second connectors are attached to the first and second desired positions, respectively, the first and second portions being configured to allow the part to slide along the first and second portions and into the first and second desired positions while the part is lifted by the handle member, the first and second connectors being removable from the first and second desired positions after the part has been slid into the first and second desired positions.

9. The system of claim 8 for use with the part being a wheel, wherein the first and second desired positions are first and second lugs,
the first connector comprises a first channel configured to receive the first lug, and
the second connector comprises a second channel configured to receive the second lug.

10. The system of claim 8, wherein the first and second desired positions are first and second openings,
the first connector comprises a first end portion configured to be received inside the first opening, and
the second connector comprises a second end portion configured to be received inside the second opening.

11. The system of claim 8, wherein the handle member is a cable.

12. A system for use with a wheel comprising a plurality of through-holes and a wheel hub assembly with a plurality of holes, the system comprising:
first and second adapters each having a first end portion opposite a second end portion, the second end portion of the first adapter being configured to be received inside a first one of the plurality of holes, the second end portion of the second adapter being configured to be received inside a second one of the plurality of holes;
a first connector comprising a first channel configured to receive the first end portion of the first adapter, the first connector being configured to pass through a first one of the plurality of through-holes;
a second connector comprising a second channel configured to receive the first end portion of the second adapter, the second connector being configured to pass through a second one of the plurality of through-holes; and
a handle member having a first portion connected to the first connector and a second portion connected to the second connector, the first and second portions being configured to pass through the first and second through-holes, respectively, the handle member being configured to lift the wheel while the first and second end portions of the first adapter are received inside the first channel and the first hole, respectively, and the first and second end portions of the second adapter are received inside the second channel and the second hole, respectively, the first and second portions being configured to allow the wheel to slide along the first and second portions and onto the first and second adapters while the wheel is lifted by the handle member, the first and second connectors being removable from the first and second adapters after the wheel has been slid onto the first and second adapters, the first and second adapters being removable from the first and second holes after the wheel has been slid onto the first and second adapters.

13. The system of claim 12, wherein each of the first and second adapters is a stud bolt.

14. A method comprising:
passing a connector through a through-hole formed in a part, the connector being attached to a handle member, a first portion of the handle member being positioned inside the through-hole after the connector is passed through the through-hole;
attaching the connector to a desired position on one or more objects;
lifting a second portion of the handle member to thereby lift the part, the second portion being spaced apart from both the connector and the first portion;
sliding the part along the handle member while the part is lifted until at least a portion of the connector is positioned within the through-hole;
attaching the part to the one or more objects after the portion of the connector has been positioned within the through-hole; and
removing the connector from the desired position after the part has been attached to the one or more objects.

15. A method comprising:
passing a first connector through a first through-hole formed in a wheel, the first connector being attached to a first portion of a handle member, the first portion being positioned inside the first through-hole after the first connector is passed through the first through-hole;
passing a second connector through a second through-hole formed in the wheel, the second connector being attached to a third portion of the handle member, the third portion being positioned inside the second through-hole after the second connector is passed through the second through-hole;
attaching the first connector to a first lug mounted on a wheel hub assembly;
attaching the second connector to a second lug mounted on the wheel hub assembly;
lifting a second portion of the handle member to thereby lift the wheel, the second portion being between the first and second portions;
sliding the wheel along the handle member while the wheel is lifted until at least a first portion of the first connector is positioned within the first through-hole and at least a second portion of the second connector is positioned within the second through-hole;
attaching the wheel to the wheel hub assembly after the first and second portions of the first and second connectors, respectively, have been positioned within the first and second through-holes, respectively; and
removing the first and second connectors from the first and second lugs, respectively, after the wheel has been attached to the wheel hub assembly.

16. The method of claim 15, wherein the handle member is a cable.

17. The method of claim 15, wherein attaching the wheel to the wheel hub assembly comprises:
attaching a third lug nut to a third lug mounted on the wheel hub assembly.

18. The method of claim 17, further comprising:
attaching a first lug nut to the first lug after the first connector has been removed from the first lug; and
attaching a second lug nut to the second lug after the second connector has been removed from the second lug.

19. The method of claim 17, further comprising:
tightening the third lug nut after the first and second connectors have been removed from the first and second lugs, respectively.

20. A method comprising:
passing a first connector through a first through-hole formed in a wheel, the first connector being attached to a first portion of a first handle member, the first portion of the first handle member being positioned inside the first through-hole after the first connector is passed through the first through-hole;
passing a second connector through a second through-hole formed in the wheel, the second connector being attached to a first portion of a second handle member, the first portion of the second handle member being positioned inside the second through-hole after the second connector is passed through the second through-hole;
attaching the first connector to a first lug mounted on a wheel hub assembly;
attaching the second connector to a second lug mounted on the wheel hub assembly;
lifting second portions of the first and second handle members onto a stand to thereby lift the wheel;
sliding the wheel along the first and second handle members while the wheel is lifted until at least a first portion of the first connector is positioned within the first through-hole and at least a second portion of the second connector is positioned within the second through-hole;
attaching the wheel to the wheel hub assembly after the first and second portions of the first and second connectors, respectively, have been positioned within the first and second through-holes, respectively;
removing the second portions of the first and second handle members from the stand; and
removing the first and second connectors from the first and second lugs, respectively, after the wheel has been attached to the wheel hub assembly.

21. The method of claim 20, wherein the first portions of the first and second handle members are flexible, and
the second portions of the first and second handle members are rigid.
